(19) United States
(12) Patent Application Publication
(10) Pub. No.: US 2024/0219529 A1
(43) Pub. Date: Jul. 4, 2024

(54) LIDAR CONTROLLING METHOD AND APPARATUS, TERMINAL DEVICE AND COMPUTER-READABLE STORAGE MEDIUM

(71) Applicant: SUTENG INNOVATION TECHNOLOGY CO., LTD., Shenzhen (CN)

(72) Inventors: Huazhou CHEN, Shenzhen (CN); Jie LUO, Shenzhen (CN); Yajun DU, Shenzhen (CN)

(73) Assignee: SUTENG INNOVATION TECHNOLOGY CO., LTD., Shenzhen (CN)

(21) Appl. No.: 18/389,753

(22) Filed: Dec. 19, 2023

(30) Foreign Application Priority Data
Dec. 29, 2022 (CN) 202211707101.3

(51) Int. Cl. G01S 7/484; G01S 17/89; G01S 17/931

(52) U.S. Cl. CPC G01S 7/484; G01S 17/89; G01S 17/931

(57) ABSTRACT

This application is applicable to the field of LiDAR technologies, and provides a LiDAR controlling method and apparatus, a terminal device. The method includes: grouping all parallel channels of the LiDAR based on physical intervals between the parallel channels; and controlling parallel channels in different groups to emit detection signals based on an intergroup emission policy, where the intergroup emission policy is to control a time interval between emission times of the parallel channels in the different groups to be a first preset time interval, and the first preset time interval is greater than a recovery time of a sensor between two adjacent signal emissions.

### CROSS-REFERENCE TO RELATED APPLICATION

The present application claims the benefit of priority to Chinese Patent Application No. 202211707101.3, filed on Dec. 29, 2022, which is hereby incorporated by reference in its entirety.

### TECHNICAL FIELD

This application pertains to the field of LiDAR technologies, and particularly relates to a LiDAR controlling method, a terminal device, and a computer-readable storage medium.

### TECHNICAL BACKGROUND

A LIDAR is usually used in fields such as automated driving, transport vehicles, robots, and public smart transportation due to their advantages such as high resolution, high sensitivity, strong anti-interference ability, and adaptability under dark conditions.

To improve detection accuracy of the LiDAR, a LiDAR with multiple parallel channels is usually used for detection, and the LiDAR usually includes multiple laser emitters and multiple laser receivers arranged densely. In the LiDAR, each laser emitter corresponds to an emission channel, and each laser receiver corresponds to one receiving channel, to form a complete transceiving detection system of the LiDAR via a corresponding emission channel and receiving channel. However, due to current improvement of detection accuracy in the field of LiDAR, the laser emitter and the laser receiver are densely arranged, thereby causing optical crosstalk between adjacent channels of the LiDAR in large part.

### SUMMARY

Embodiments of this application provide a LiDAR controlling method and apparatus, a terminal device and a non-transitory computer-readable storage medium, which can reduce crosstalk between parallel channels.

According to a first aspect, an embodiment of this application provides a LiDAR controlling method, including:
grouping all parallel channels of the LiDAR based on physical intervals between the parallel channels, where a physical interval between any adjacent parallel channels in the same group is greater than or equal to a preset physical interval; and
controlling parallel channels in different groups to emit detection signals based on an intergroup emission policy, where the intergroup emission policy is to control a time interval between emission times of the parallel channels in the different groups to be a first preset time interval, and the first preset time interval is greater than a recovery time of a sensor between two adjacent signal emissions.

In an embodiment of the first aspect, after grouping all parallel channels of the LiDAR based on physical intervals between the parallel channels, the method further includes:
controlling a parallel channel in each group to emit a detection signal based on an intragroup emission policy, where the intragroup emission policy is to control the parallel channel in the group to perform emission based on a first emission code set, and emission sequences during emissions are different, where a difference between any two emission codes in the first emission code set is less than the first preset time interval.

In an embodiment of the first aspect, before grouping all parallel channels of the LiDAR based on physical intervals between the parallel channels, the method further includes:
setting a preset physical interval based on the number of parallel channels and the number of groups within an analysis region time.

In an embodiment of the first aspect, within the analysis region time, the number of parallel channels is N and the number of groups is M, and grouping all parallel channels of the LiDAR based on physical intervals between the parallel channels includes:
dividing N parallel channels into M groups based on the number of groups and the preset physical interval, where each group includes K parallel channels, M is a positive integer greater than or equal to 2, N is a positive integer greater than or equal to 2, K is a positive integer, N=M*K, and physical intervals between K parallel channels are all greater than the preset physical interval.

In an embodiment of the first aspect, a degree of cross-correlation of any two emission codes in the first emission code set is less than a preset threshold.

In an embodiment of the first aspect, before controlling parallel channels in different groups to emit detection signals based on an intergroup emission policy, the method further includes: obtaining a detection region of a parallel channel group; and setting the first preset time interval based on the detection region.

In an embodiment of the first aspect, setting the first preset time interval based on the detection region includes: determining analysis region duration based on the maximum detection distance of the detection region; and setting the first preset time interval based on the analysis region duration.

According to a second aspect, an embodiment of this application provides a LiDAR controlling apparatus, including:
a grouping module, configured to group all parallel channels of the LiDAR based on physical intervals between the parallel channels, where a physical interval between any adjacent parallel channels in the same group is greater than or equal to a preset physical interval; and
a controlling module, configured to control parallel channels in different groups to emit detection signals based on an intergroup emission policy, where the intergroup emission policy is to control a time interval between emission times of the parallel channels in the different groups to be a first preset time interval, and the first preset time interval is greater than a recovery time of a sensor between two adjacent signal emissions.

According to a third aspect, an embodiment of this application provides a terminal device, where the terminal device includes a processor, a memory, and a computer program stored in the memory and capable of running on the processor, where when the processor executes the computer program, the LiDAR controlling method according to the first aspect or any embodiment of the first aspect is implemented.

According to a fourth aspect, an embodiment of this application provides a computer-readable storage medium, where the computer-readable storage medium stores a computer program, and when the computer program is executed by a processor, the LiDAR controlling method according to the first aspect or any embodiment of the first aspect is implemented.

According to a fifth aspect, an embodiment of this application provides a computer program product, where when the computer program product runs on a terminal device, the terminal device performs the LiDAR controlling method according to the first aspect or any embodiment of the first aspect.

In the LiDAR controlling method provided in the embodiments of this application, parallel channels at small physical intervals are allocated to different emission groups, emissions of different groups are at the first preset time intervals. When an object is detected, received echoes are directly at intervals in the time domain, and because the time interval is greater than the recovery time of the sensor, echo signals do not affect each other from the perspective of time, thereby avoiding the crosstalk between the two parallel channels.

### BRIEF DESCRIPTION OF DRAWINGS

To explain the technical solution in embodiments in this application, the following briefly introduces the accompanying drawings required to describe the embodiments. Obviously, the accompanying drawings in the following description are only some embodiments in this application.

FIG. 1 is a schematic flowchart of implementation of a LiDAR controlling method according to an embodiment;

FIG. 2 is a schematic diagram of grouping of parallel channels of a LiDAR according to an embodiment;

FIG. 3 is a schematic diagram of an emission sequence in an intergroup emission policy in a LiDAR controlling method according to an embodiment;

FIG. 4 is a schematic flowchart of implementation of another LiDAR controlling method according to an embodiment;

FIG. 5 is a schematic diagram of an emission sequence in an intergroup emission policy in a LiDAR controlling method according to an embodiment;

FIG. 6 is a schematic diagram of signal receiving in an intragroup emission policy in a LiDAR controlling method according to an embodiment;

FIG. 7 is a schematic structural diagram of a LiDAR controlling apparatus according to an embodiment; and

FIG. 8 is a schematic structural diagram of a terminal device according to an embodiment.

### DETAILED DESCRIPTION

For purpose of illustration rather than limitation, the following describes details such as a system structure and technology, to facilitate a thorough understanding of the embodiments of this application.

The term “and/or” used in this specification and appended claims of this application refers to any combination of one or more of the associated items listed and all possible combinations thereof, and inclusion of these combinations. In the descriptions of this specification and the appended claims of this application, the terms “first,” “second,” “third,” and the like are merely intended for differential description, and should not be understood as any indication or implication of relative importance.

Reference to “an embodiment,” “some embodiments,” or the like described in this specification of this application means that one or more embodiments of this application include a feature, structure, or characteristic described with reference to the embodiments. Therefore, expressions such as “in an embodiment,” “in some embodiments,” “in some other embodiments,” and “in some additional embodiments” appearing in different places in this specification do not necessarily indicate reference to the same embodiment, but mean “one or more but not all embodiments,” unless otherwise specified in another way. The terms “include,” “comprise,” “have,” and variants thereof all mean “including but not limited to,” unless otherwise specified in another way.

Vehicle-mounted LiDAR can obtain three-dimensional images of physical space to detect a driving environment. During autonomous driving, a LiDAR needs to be capable of identifying a small target object at a long distance with high accuracy. To improve the accuracy of identifying the small target object at the long distance by the LiDAR, a LiDAR with multiple parallel channels is usually used for detection, and the LiDAR usually includes multiple laser emitters and multiple laser receivers arranged densely. In the LiDAR, each laser emitter corresponds to an emission channel, and each laser receiver corresponds to one receiving channel, to form a complete transceiving detection channel of the LiDAR via a corresponding emission channel and receiving channel. However, due to current improvement of detection accuracy in the field of LiDAR, the laser emitter and the laser receiver are densely arranged, which makes it difficult for an optical design of the LiDAR to avoid optical crosstalk between adjacent channels. Therefore, there is the optical crosstalk between the adjacent channels in the LiDAR in large part.

An embodiment of this application provides a LiDAR controlling method, where all parallel channels of the LiDAR are grouped based on physical intervals between the parallel channels, so that parallel channels at physical intervals less than a preset physical interval are in different groups. In addition, emissions of parallel channels in different groups are controlled to be at certain time intervals, so that echo signals corresponding to the emitted detection signals do not affect each other from the perspective of time, to avoid crosstalk between these two adjacent parallel channels, which can effectively reduce crosstalk between the adjacent channels.

The LiDAR controlling method provided in this embodiment of this application is described in detail below.

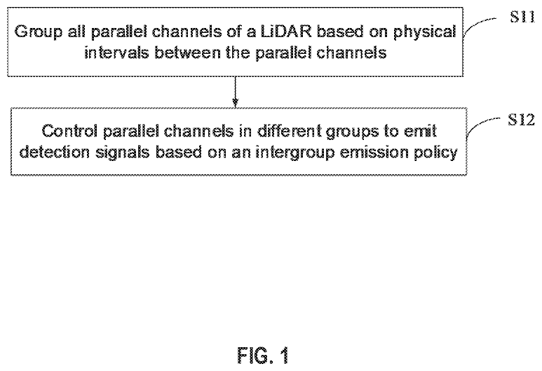

Referring to FIG. 1, FIG. 1 is a schematic flowchart of a LiDAR controlling method according to an embodiment. An execution body of the LiDAR controlling method provided in this embodiment of this application may be the LiDAR, a control system or a module inside the LiDAR, or a terminal device that is communicatively connected to the LiDAR. The terminal device may be a mobile terminal such as smartphone, tablet computer, or wearable device, or may be a device such as computer, cloud server, or LiDAR-assisted computer in various application scenarios. An example using the LiDAR as the execution body is used for description below.

As shown in FIG. 1, the LiDAR controlling method provided in an embodiment of this application may include step S11 to step S12. Details are as follows.

S11. Group all parallel channels of a LiDAR based on a physical interval between parallel channels.

A physical interval between any adjacent parallel channels in the same group is greater than or equal to a preset physical interval. That is, parallel channels at physical intervals less than a preset physical interval are divided into different groups.

The physical interval between the channels is related to a size of a scanning light spot of the channels and arrangement of emitters.

In an embodiment, the parallel channels at the physical intervals less than the preset physical intervals are divided into different groups, so that a physical interval between the parallel channels in each group is greater than or equal to the preset physical interval. The parallel channels of the LiDAR are separated via grouping.

The foregoing physical interval refers to a physical interval between adjacent channels in each group of parallel channels.

In this embodiment of this application, before step S11, the method may further include the following step.

Set a preset physical interval based on the number of parallel channels and the number of groups within an analysis region time. Assuming that there are N parallel channels in analysis region time t, that is, the N parallel channels can be divided into M groups based on the number M of groups, there are K parallel channels in each group, and a physical interval between parallel channels in the K parallel channels is greater than the preset physical interval. Herein, N=M*K, where M is a positive integer greater than or equal to 2, N is a positive integer greater than or equal to 2, and K is a positive integer.

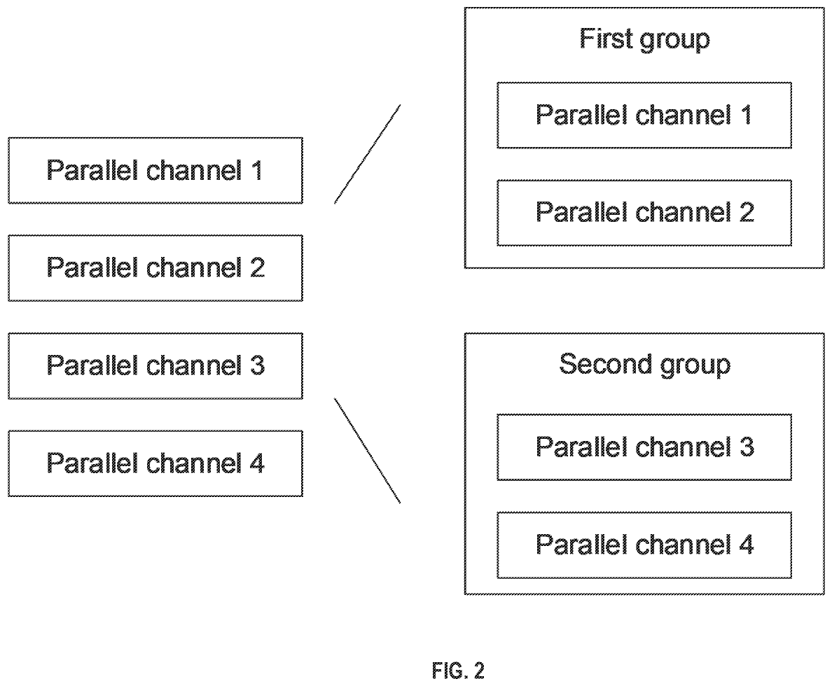

Exemplarily, as shown in FIG. 2, assuming that there are 4 parallel channels in the analysis region time t, namely, a parallel channel 1, a parallel channel 2, a parallel channel 3, and a parallel channel 4, the parallel channel 1 is adjacent to the parallel channel 2, the parallel channel 2 is adjacent to the parallel channel 3, and the parallel channel 3 is adjacent to the parallel channel 4. That is, a physical interval between the parallel channel 1 and the parallel channel 2 is 1, a physical interval between the parallel channel 1 and the parallel channel 3 is 2, a physical interval between the parallel channel 1 and the parallel channel 4 is 3, a physical interval between the parallel channel 2 and the parallel channel 3 is 1, a physical interval between the parallel channel 2 and the parallel channel 4 is 2, and a physical interval between the parallel channel 3 and the parallel channel 4 is 1. Assuming that the number M of groups is 2, the preset physical interval can be determined as 2. A grouping result is as follows: The first group: the parallel channel 1 and the parallel channel 3; and the second group: the parallel channel 2 and the parallel channel 4. That is, parallel channels at physical intervals less than 2 are in different groups, and the physical interval between the parallel channels in each group is greater than or equal to 2.

S12. Control parallel channels in different groups to emit detection signals based on an intergroup emission policy.

In an embodiment, the intergroup emission policy is to control a time interval between emission times of the parallel channels in the different groups to be a first preset time interval.

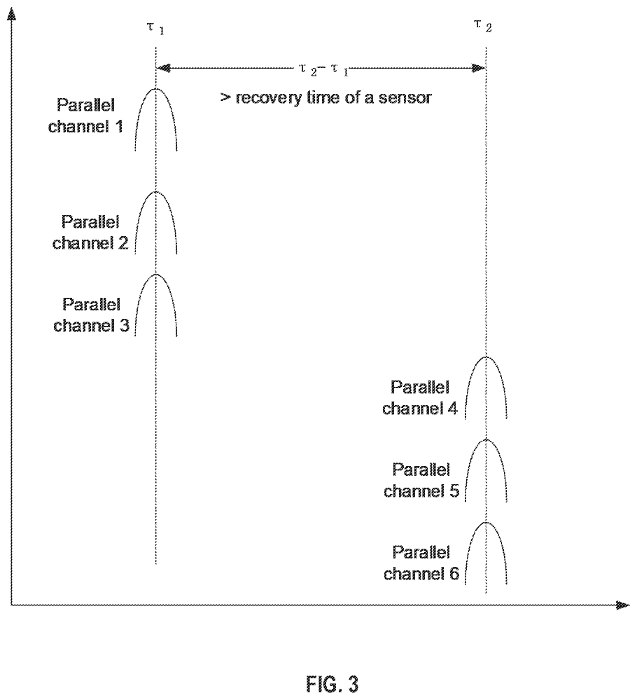

Exemplarily, referring to FIG. 3, assuming that there are a total of 6 parallel channels (namely, a parallel channel 1, a parallel channel 2, a parallel channel 3, a parallel channel 4, a parallel channel 5, and a parallel channel 6 in FIG. 3), and that these 6 parallel channels are divided into 2 groups, the parallel channel 1, the parallel channel 3, and the parallel channel 5 are the first group, and the parallel channel 2, the parallel channel 4, and the parallel channel 6 are the second group. Then the LiDAR controls the parallel channel 1, the parallel channel 3, and the parallel channel 5 to emit detection signals at a first emission time τ1, and controls the parallel channel 2, the parallel channel 4, and the parallel channel 6 to emit detection signals at a second emission time τ2, and a time interval between the first emission time τ1 and the second emission time τ2 is the first preset time interval (τ2−τ1).

In an embodiment, to avoid interference to the received signal after the detection signals are emitted via the parallel channels in different groups, the first preset time interval needs to be greater than the recovery time of the sensor during the two adjacent signal emissions of the LiDAR.

The recovery time of the sensor during the two adjacent signal emissions of the LiDAR refers to time required for a sensed value of the sensor to be reset to 0 after the sensor receives an echo signal at a previous signal emission. The recovery time of the sensor can be determined according to an actual scenario and device performance.

In an embodiment, the LiDAR first controls the first group of parallel channels to emit detection signals at a first moment, controls the second group of parallel channels to emit detection signals after the first preset time interval, controls the third group to emit detection signals in parallel after the second preset time interval, and repeats such operation until detection signals are emitted via an M^{th} group of parallel channels.

As parallel channels at small physical intervals are allocated to different emission groups, the parallel channels at the small physical intervals are likely to detect the same object, and have echoes requiring close times of flight of photons. Emissions of different groups are at the first preset time intervals. When an object is detected, received echoes are directly at intervals in the time domain, and because the time interval is greater than the recovery time of the sensor, two pulses do not affect each other from the perspective of time, thereby avoiding the crosstalk between the two parallel channels.

The LiDAR controlling method provided in this embodiment of this application may be applied to both LiDAR using parallel channels for emissions and LiDAR using a combination of serial and parallel channels. Parallel channels are controlled in the controlling method provided in this embodiment of this application, and then an emission of the serial channels is performed with reference to an emission mode of the serial channels, which can also effectively reduce crosstalk between the channels of the LiDAR.

As different detection regions correspond to different analysis region duration, analysis region duration t corresponding to emission and reception channels of different detection regions satisfies:

NL/c<τ

N is the number of parallel channels, c is the speed of light, L is the maximum detection distance of the LiDAR, and t is a time required for N parallel channels to complete one emission, and is recorded as analysis region duration t.

As the maximum detection distances set for different detection regions of the LiDAR are unequal, the different detection regions correspond to unequal maximum analysis region duration. For example, a detection distance set for a central detection region is greater than a detection distance for an edge region, and therefore, analysis region duration for the central detection region is greater than analysis region duration for the edge detection region. Therefore, the detection region corresponding to the parallel channel group can be further determined, and then the first preset time interval is set based on the detection region corresponding to the parallel channel group. Assuming that the detection region corresponding to the parallel channel group is the central detection region, the first preset time interval is the first time interval. Assuming the detection region corresponding to the parallel channel group is the edge detection region, the first preset time interval is the second time interval. The first time interval is greater than the second time interval.

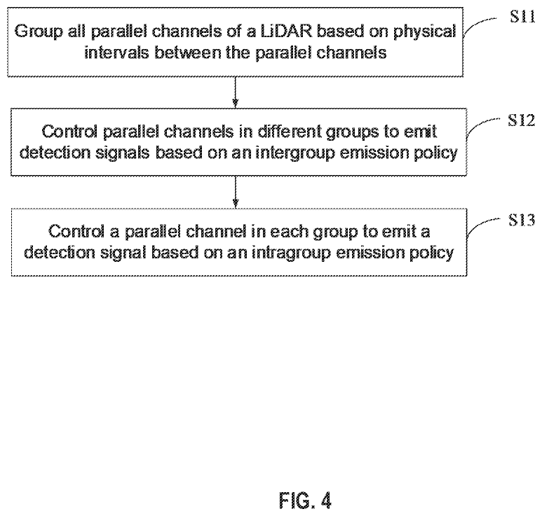

Referring to FIG. 4, in an embodiment of this application, the LiDAR controlling method may further include the following steps:

S13. Control a parallel channel in each group to emit a detection signal based on an intragroup emission policy.

In an embodiment, the intragroup emission controlling policy is to control the parallel channel in the group to perform emission based on a first emission code set, and emission sequences during emissions are different. A difference between any two emission codes in the first emission code set is less than the first preset time interval.

In an embodiment, for the parallel channels in the same group, emissions are at small time intervals (via the first emission code set), for example, 1 ns to 10 ns. In this way, the interval is very small, and compared with the time interval between different groups, the interval has a small impact on the entire analysis region. The effect of crosstalk can be further effectively reduced by diversifying the sequence during each emission.

In this embodiment of this application, the emission times (that is, the first emission code set) of the parallel channels in the same group satisfy an intragroup jitter requirement. That is, cross-correlation of any two emission codes in the first emission code set is less than a preset threshold.

The intragroup jitter requirement is intended to ensure that emissions of the parallel channels for parallel emissions in the group are at small time intervals, to implement emissions at staggered sequences (that is, emission sequences of different parallel channels are different during each emission) and reduce mutual interference between signals emitted through the parallel channels.

In an embodiment, the first emission code set can be random. That is, emission times of the same group are random. A pseudorandom sequence can be used as a jitter time code sequence of the parallel channels. That is, the first emission code set is set based on the pseudorandom sequence. However, if cross-correlation between the pseudo-random sequences is larger, the laser beams emitted via the emission channels for the parallel emissions are prone to interfere with another channel. Therefore, to reduce the interference between the parallel channels, a cross-correlation function of each pseudo-random sequence may be obtained. The correlation degree of the emission times (emission codes) of the emission channels may be calculated based on the cross-correlation function. Jitter delay with the degree of cross-correlation less than a preset threshold is selected.

In an embodiment, the cross-correlation function of the plurality of pseudo-random sequences may be determined by the following formula:

$$CCR ( a , b , τ ) = {\sum }_{i = 0}^{P} {a}_{i} {b}_{i + τ} ;$$

Here, CCR(a,b,τ) is a cross-correlation function, aᵢ, and b_{i+τ} represent pseudo-random code sequences corresponding to adjacent emission channels for parallel emissions.

A group of pseudorandom sequences with a cross-correlation coefficient less than the preset threshold is selected as a group of jitter delay of parallel channels. Jitter delay corresponding to each emission channel in the LiDAR can be determined in the foregoing method.

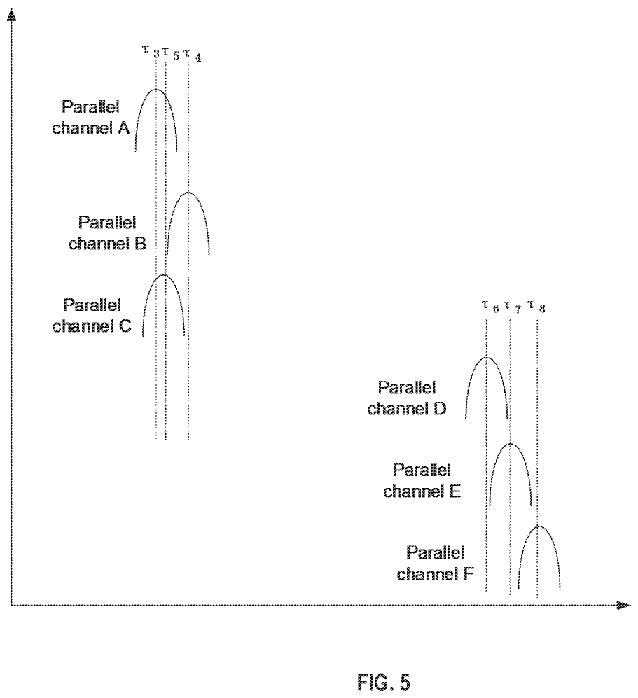

Exemplarily, referring to FIG. 5, FIG. 5 is a schematic diagram of an emission sequence in an intergroup emission policy in a LiDAR controlling method according to an embodiment of this application.

As shown in FIG. 5, an emission time of a parallel channel A in the first group is τ₃, an emission time of a parallel channel B is τ₄, and an emission time of a parallel channel C is τ₅; and an emission time of a parallel channel D in the second group is τ₆, an emission time of a parallel channel E is τ₇, and an emission time of a parallel channel F is τ₈. The emission time τ₃ of the parallel channel A is prior to the emission time τ₄ of the parallel channel B, and the emission time τ₅ of the parallel channel C is prior to the emission time τ₄ of the parallel channel B; and the emission time to of the parallel channel D is prior to the emission time τ₇ of the parallel channel E, and the emission time τ₇ of the parallel channel E is prior to the emission time 18 of the parallel channel F.

In this embodiment of this application, in the intergroup controlling policy, emission time intervals between different parallel channels in the same group are different.

Exemplarily, assuming that there are the parallel channel A, the parallel channel B, and the parallel channel C in the group, an interval between an emission time of the parallel channel A and an emission time of the parallel channel B can be unequal to an interval between the emission time of the parallel channel B and an emission time of the parallel channel C.

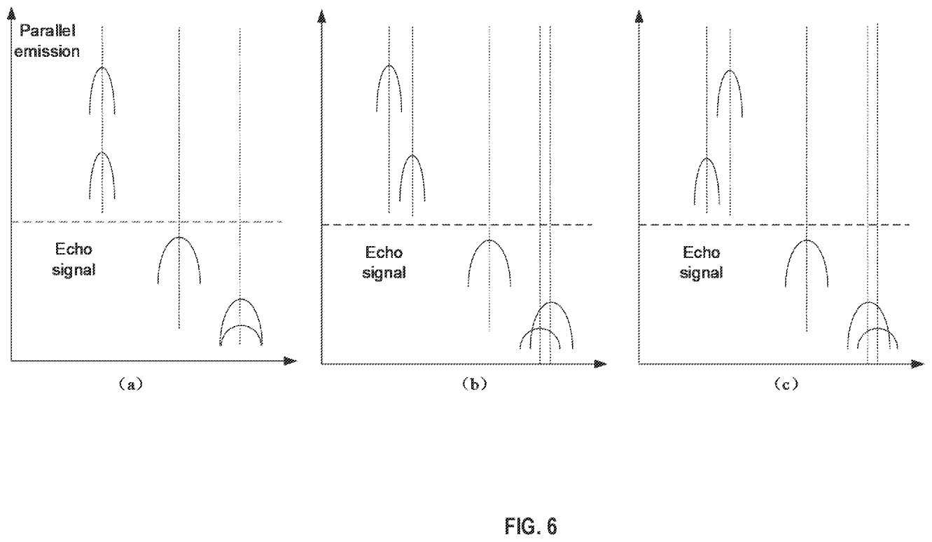

Exemplarily, referring to FIG. 6, FIG. 6 is a schematic diagram of signal receiving in an intragroup emission policy in a LiDAR controlling method according to an embodiment of this application.

Assuming that the parallel channel A and the parallel channel B in the same group, during the first emission, the emission time of the parallel channel A is prior to the emission time of the parallel channel B, and during the second emission, the emission time of the parallel channel B is prior to the emission time of the parallel channel A.

In an embodiment, the parallel channel A and the parallel channel B detect objects that are physically staggered. In this case, crosstalk between the parallel channel A and the parallel channel B does not occur. In some cases, if the parallel channel A or the parallel channel B detects an object with high reflectivity, an echo received via the parallel channel A causes crosstalk to an echo received via the parallel channel B. This causes a detection problem to the parallel channel B (which makes it impossible to distinguish between the echo and the crosstalk, as shown in a part (a) of FIG. 6).

There is a small time interval between the parallel channel A and the parallel channel B. When the parallel channel A detects the object with high reflectivity and emission of the parallel channel A is prior to that of the parallel channel B, a crosstalk signal affects the parallel channel B (as shown in a part (b) in FIG. 6) (generally, only a rising edge is required for signal detection). During out-of-sequence emissions (that is, emission sequences of different parallel channels are different during the emissions), when the emission of the parallel channel B is prior to that of the parallel channel A, a crosstalk signal is later than the actual echo signal of the parallel channel B (as shown in a part (c) in FIG. 6). When the rising edge is detected, the actual echo signal of the parallel channel B can be detected via such a policy. Emitting the detection signal based on the intragroup emission policy can improve a detection rate of the actual echo signal and reduce crosstalk interference.

A sequence number of each step in the foregoing embodiments does not mean an execution sequence. An execution sequence of each process should be determined based on a function and internal logic of each process.

Embodiments of the present disclosure further provide an embodiment of a LiDAR controlling apparatus for implementing the foregoing method embodiment.

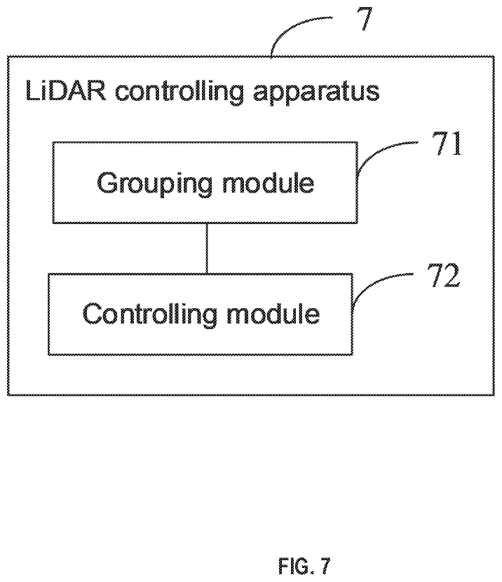

Referring to FIG. 7, FIG. 7 is a schematic structural diagram of a LiDAR controlling apparatus according to an embodiment of this application. In an embodiment of this application, each unit included in the LiDAR controlling apparatus is configured to perform each step in the embodiment corresponding to FIG. 1. For details, refer to FIG. 1 and related descriptions in the embodiment corresponding to FIG. 1. For ease of description, only a portion related to this embodiment is shown. As shown in FIG. 7, the LiDAR controlling apparatus 6 includes a grouping module 71 and a controlling module 72.

The grouping module 71 is configured to group all parallel channels of the LiDAR based on physical intervals between the parallel channels, where a physical interval between any adjacent parallel channels in the same group is greater than or equal to a preset physical interval.

The controlling module 72 is configured to control parallel channels in different groups to emit detection signals based on an intergroup emission policy, where the intergroup emission policy is to control a time interval between emission times of the parallel channels in the different groups to be a first preset time interval, and the first preset time interval is greater than a recovery time of a sensor.

In an embodiment of this application, the controlling module 63 is further configured to control a parallel channel in each group to emit a detection signal based on an intragroup emission policy, where the intragroup emission policy is to control the parallel channel in the group to perform emission at second preset time intervals, and emission sequences during emissions are different, where the second preset time interval is less than the first preset time interval.

In an embodiment of this application, the LiDAR controlling apparatus further includes a setting module.

The foregoing setting module is configured to set a preset physical interval based on the number of parallel channels and the number of groups within an analysis region time.

In an embodiment of this application, within the analysis region time, the number of parallel channels is N and the number of groups is M, and the foregoing grouping module 71 is specifically configured to divide N parallel channels into M groups based on the number of groups and the preset physical interval, where each group includes K parallel channels, M is a positive integer greater than or equal to 2, N is a positive integer greater than or equal to 2, K is a positive integer, N=M*K, and physical intervals between K parallel channels are all greater than the preset physical interval.

In an embodiment of this application, the controlling module 72 is configured to control the first group of parallel channels to emit detection signals at a first moment, control the second group of parallel channels to emit detection signals after the first preset time interval, control the third group to emit detection signals in parallel after the second preset time interval, and repeat such operation until detection signals are emitted via an M^{th} group of parallel channels.

Content such as information exchange and an execution process between the foregoing units is based on the same concept as the method embodiments of this application. For functions and technical effects thereof, reference may be made to the method embodiments.

In conclusion, based on the LiDAR controlling apparatus provided in the embodiments of this application, emissions of different parallel emission groups can also be at the first preset time intervals. When an object is detected, received echoes are directly at intervals in the time domain, and because the time interval is greater than the recovery time of the sensor, echo signals do not affect each other from the perspective of time, thereby avoiding the crosstalk between the two parallel channels.

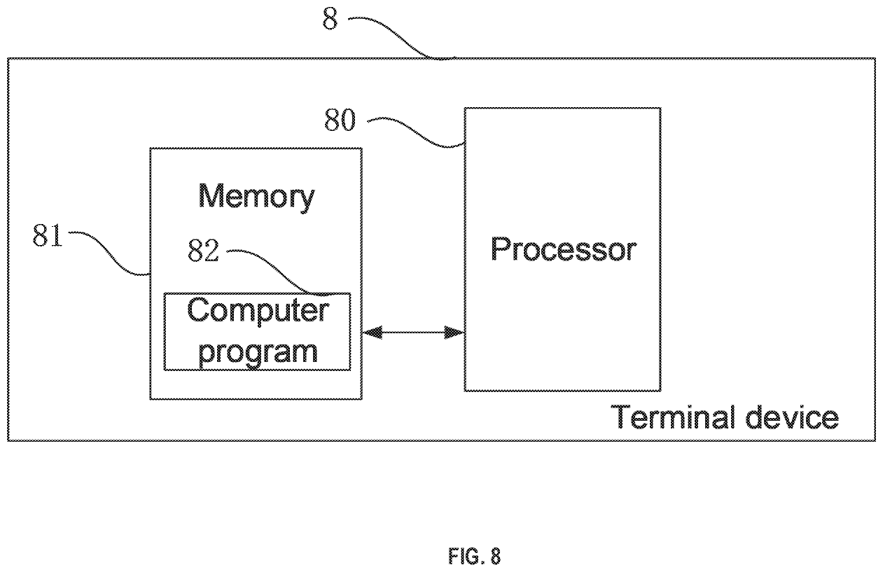

FIG. 8 is a schematic structural diagram of a terminal device provided by another embodiment of the present application. As shown in FIG. 8, the terminal device 8 provided by the embodiment includes a processor 80, a memory 81, and computer program 82 stored in the memory 81 and executable on the processor 80, for example, an image segmentation program. When executing the computer program 82, the processor 80 performs the steps in each embodiment of the LiDAR controlling method, for example, step S11 to step S12 shown in FIG. 1. Alternatively, when executing the computer program 82, the processor 80 implements functions of the modules or units in each embodiment of the terminal device, for example, functions of the units 71 to 72 shown in FIG. 7.

Exemplarily, the computer program 82 can be divided into one or more modules/units. The one or more modules/units are stored in the storage 81 and executed by the processor 80 to complete this application. The one or more modules/units can be a series of computer program instruction fields capable of performing specific functions. The instruction fields are configured to describe an execution process of the computer program 82 in the terminal device 8. For example, the computer program 82 can be divided into a plurality of units. For functions of the units, refer to relevant descriptions in the embodiment corresponding to FIG. 7.

The terminal device may include, but not limited to, the processor 80 and the memory 81. FIG. 8 is an example of the terminal device 8. The terminal device may include more or fewer components than those shown in the figure, or a combination of some components, or different components. For example, the terminal device may also include input and output devices, a network access device, a bus, and the like.

The processor 80 may be a central processing unit (CPU), or may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor can be a microprocessor, or the processor can be any conventional processor or the like.

The memory 81 may be an internal storage unit of the terminal device 8, such as a hard disk or a memory of the terminal device 8. The memory 81 may alternatively be an external storage device of the terminal device 8, for example, a plug-connected hard disk, a smart media card (SMC), a secure digital (SD) card, or a flash card (Flash Card) equipped on the terminal device 8. Further, the memory 81 may alternatively include both the internal storage unit and the external storage device of the terminal device 8. The memory 81 is configured to store the computer program and other programs and data required by the terminal device. The memory 81 can also be configured to temporarily store output data or to-be-output data.

An embodiment of this application also provides a non-transitory computer-readable storage medium. The computer-readable storage medium stores a computer program, and when the computer program is executed by the processor, the foregoing LiDAR controlling method can be implemented.

An embodiment of this application provides a computer program product, where when the computer program product runs on a terminal device, the terminal device performs the foregoing LiDAR controlling method.

For ease and brevity of description, division of the foregoing functional units and modules is taken as an example for illustration. In an embodiment, the foregoing functions can be allocated to different units and modules and implemented according to a requirement, that is, an inner structure of the terminal device is divided into different functional units and modules to implement all or a part of the functions described above. The functional units and modules in the embodiments may be integrated into one processing unit, or each unit may exist alone physically, or two or more units may be integrated into one unit. The integrated unit may be implemented in a form of hardware, or may be implemented in a form of a software functional unit. In addition, names of the functional units and modules are only for the convenience of distinguishing one another. For a detailed working process of units and modules in the foregoing system, reference may be made to a corresponding process in the foregoing method embodiments.

In the foregoing embodiments, the descriptions of the embodiments have respective focuses. For a part that is not described in detail in one embodiment, reference may be made to related descriptions in other embodiments.

The units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions.

What is claimed is:

1. A LIDAR controlling method, comprising:
grouping all parallel channels of a LiDAR based on physical intervals between the parallel channels, wherein a physical interval between any adjacent parallel channels in a same group is greater than or equal to a preset physical interval; and
controlling parallel channels in different groups to emit detection signals based on an intergroup emission policy, wherein the intergroup emission policy is to control a time interval between emission times of the parallel channels in the different groups to be a first preset time interval, and the first preset time interval is greater than a recovery time of a sensor between two adjacent signal emissions.

2. The LiDAR controlling method according to claim 1, wherein after grouping all the parallel channels of the LiDAR based on the physical intervals between the parallel channels, the method further comprises:
controlling a parallel channel in each group to emit a detection signal based on an intragroup emission policy, wherein the intragroup emission policy is to control the parallel channel in the group to perform emission based on a first emission code set, and emission sequences during emissions are different, wherein a difference between any two emission codes in the first emission code set is less than the first preset time interval.

3. The LiDAR controlling method according to claim 1, wherein before grouping all the parallel channels of the LiDAR based on the physical intervals between the parallel channels, the method further comprises:
setting a preset physical interval based on a number of parallel channels and a number of groups within an analysis region time.

4. The LiDAR controlling method according to claim 3, wherein within the analysis region time, the number of parallel channels is N and the number of groups is M, and the grouping all the parallel channels of the LiDAR based on the physical intervals between the parallel channels further comprises:
dividing N parallel channels into M groups based on the number of groups and the preset physical interval, wherein each group comprises K parallel channels, M is a positive integer greater than or equal to 2, N is a positive integer greater than or equal to 2, K is a positive integer, N=M*K, and physical intervals between K parallel channels are all greater than the preset physical interval.

5. The LiDAR controlling method according to claim 2, wherein a degree of cross-correlation of any two emission codes in the first emission code set is less than a preset threshold.

6. The LiDAR controlling method according to claim 1, wherein before controlling the parallel channels in the different groups to emit the detection signals based on the intergroup emission policy, the method further comprises:
obtaining a detection region of a parallel channel group; and
setting the first preset time interval based on the detection region.

7. The LiDAR controlling method according to claim 6, wherein setting the first preset time interval based on the detection region comprises:
determining analysis region duration based on a maximum detection distance of the detection region; and
setting the first preset time interval based on the analysis region duration.

8. A LIDAR controlling apparatus, comprising:
a grouping module, configured to group all parallel channels of a LiDAR based on physical intervals between the parallel channels, wherein a physical interval between any adjacent parallel channels in a same group is greater than or equal to a preset physical interval; and
a controlling module, configured to control parallel channels in different groups to emit detection signals based on an intergroup emission policy, wherein the intergroup emission policy is to control a time interval between emission times of the parallel channels in the different groups to be a first preset time interval, and the first preset time interval is greater than a recovery time of a sensor between two adjacent signal emissions.

9. A terminal device, comprising a memory, a processor, and a computer program stored in the memory and capable of running on the processor, wherein when the processor executes the computer program, a LiDAR controlling method is implemented, wherein the LiDAR controlling method comprises:
grouping all parallel channels of a LiDAR based on physical intervals between the parallel channels, wherein a physical interval between any adjacent parallel channels in a same group is greater than or equal to a preset physical interval; and
controlling parallel channels in different groups to emit detection signals based on an intergroup emission policy, wherein the intergroup emission policy is to control a time interval between emission times of the parallel channels in the different groups to be a first preset time interval, and the first preset time interval is greater than a recovery time of a sensor between two adjacent signal emissions.
